(19) United States
(12) Patent Application Publication
(10) Pub. No.: US 2005/0260376 A1
(43) Pub. Date: Nov. 24, 2005

(54) Baseboard molding with adaptive and accommodating surfaces

(76) Inventor: Richard Duk Wong Hahn, Diamond Bar, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/853,417

(22) Filed: May 24, 2004

(51) Int. Cl. B44C 1/26

(52) U.S. Cl. 428/67

(57) ABSTRACT

A molding strip has a front surface and a spaced apart rear surface, the front and rear surfaces extending between parallel top and bottom edges. The front surface is decorative with a horizontal groove for accepting a decorative filler strip. The bottom surface is indented from the front surface to form a space between the molding strip and the floor below it. The rear surface comprises a plurality of parallel grooves separated by horizontal contact edges. A cutaway surface extends from the bottom edge to a medial position on the rear surface for concealing a lesser sized molding strip.

### BACKGROUND OF THE INVENTION

1. Incorporation by Reference

Applicant(s) hereby incorporate herein by reference, any and all U.S. patents and U.S. patent applications cited or referred to in this application.

2. Field of the Invention

This invention relates generally to decorative and utility molding strips especially of the type used in residential and commercial spaces for concealing the margins between floors, walls and ceilings.

3. Description of Related Art

The following art defines the present state of this field:

Roberts et al., U.S. Pat. No. 5,112,548 describes an extrusion method and apparatus for producing a molding strip, which includes a decorative Mylar plastic strip located between a pair of interbonded plastic layers. The top plastic layer or topcoat is clear so that the decorative strip can be seen therethrough. A single die is utilized to produce the molding strip. The plastic layers are both preferably flexible PVC plastic which are interbonded by interfusion between adjacent surfaces while in a molten state within a bonding chamber of the die so that the plastic layers do not separate during use of the molding strip. The topcoat is interbonded with the other plastic layer or body without requiring the clear plastic to totally encapsulate the resulting molding strip. Also, preferably, a re-enforcement wire is embedded in the plastic body within the bonding chamber to give the molding strip additional strength.

Azzar et al., U.S. Pat. No. 5,157,886 describes an extruded, thermoplastic baseboard elastomeric molding strip having opposed generally flat front and rear surfaces is provided with a plurality of closely vertically, spaced horizontal, parallel ribs projecting outwardly of the flat front surface over the full surface area thereof. The strip is formed of front and rear surface layers of thermoplastic material of the same durometer hardness with the front surface layer forming at least the tips of the front surface ribs being of a low density thermoplastic material and the balance of the strip being of high density thermoplastic material. The front and rear surface layers may be of contrasting colors. The rear surface of the strip is preferably formed with concave grooves separated by a multiplicity of fine, vertically spaced horizontal, parallel rearwardly projecting ribs with a rear, center rib between adjacent fine ribs, of a larger diameter than adjacent fine ribs separating the rear surface grooves. The rear surface configuration facilitates removing of excess wet adhesive and maintenance of flush adhesive mounting of the molding strip to a building vertical wall.

Irrgang, U.S. Pat. No. 5,219,626 describes a molding strip, particularly for vehicles, with continuous ends formed thereon. The molding strip is a plastic injection molded part and has an integrated reinforcement, which consists of at least one metal strip. The metal strip has a plurality of cut out tongues in rows along one or both lateral edges, and which extend, in whole or in separate regions of the individual tongues, out of the plane of the metal strip. The metal strip can have shaped tongues and unshaped tongues. In a row of tongues which are arranged one behind the other, unshaped tongues alternate with tongues which extend out of the plane of the metal strip at the row of tongues.

Gross et al., U.S. Pat. No. 5,286,536 describes a decorative molding strip for automobiles and the like, consisting of a polymeric body member having a stabilizing layer imbedded therein. One surface of the strip is mounted on a portion of an auto, for example, such as a bumper or a side panel, and the opposite surface is exposed and subject to impact from an outside source. The layer is made of a woven fabric, preferably of glass fibers, and allows the surface, which has been impacted to recover from indentation, thus preserving the original smooth and unblemished appearance.

Logan, U.S. Pat. No. 5,398,469 describes a decorative molding for a corner formed by a ceiling and a vertical wall comprising a thin strip of flexible plastic that is secured to the wall by an attachment allowing the molding strip along its upper and lower edges to be flexible to conform with uneven surfaces in the ceiling and/or wall. In one form the strip is attached to the wall by an adhesive. In another form, a wall track and clip arrangement is utilized to provide easy removal from the wall for paint or wallpaper application. A corner element is provided in one form in which ends of the strips are adhesively secured thereto in overlapping engagement. In another embodiment, the strips are telescopically connected to the corner element.

Logan et al., U.S. Pat. No. 5,457,923 describes a decorative molding for a corner formed by a ceiling and a vertical wall comprising a thin strip of flexible plastic that is secured to the wall by an attachment allowing the molding strip along its upper and lower edges to be flexible to conform with uneven surfaces in the ceiling and/or wall. In one form the strip is attached to the wall by an adhesive. In another form, a wall track and clip arrangement is utilized to provide easy removal from the wall for paint or wallpaper application. A corner element is provided in one form in which ends of the strips are adhesively secured thereto in overlapping engagement. In another embodiment, the strips are telescopically connected to the corner element.

Gilmore et al., U.S. Pat. No. 5,525,384 describes a flexible ornamental or protective plastic molding strip having an inserted flexible decorative cord. The flexible molding strip, which serves as a base strip has an exposed outer surface that is usually smoothly contoured but can, if desired, be provided with longitudinally extending depressed or projecting surface decoration. In the exposed surface are one or more longitudinally extending grooves. Into each groove is inserted a flexible decorative cord, preferably of a color selected to provide an appealing visual effect, usually a color which contrasts with the color of the base strip itself. The decorative cord can be easily inserted into the groove by pressing it into place either at the factory or at the job site, to harmonize with the decor. The cord can be removed and replaced at any time desired, yet will be held securely in the groove by its contact with the walls of the groove during normal use.

Gilmore, et al., U.S. Pat. No. 5,688,569 describes a flexible ornamental or protective plastic molding strip having an inserted flexible decorative cord. The flexible molding strip, which serves as a base strip has an exposed outer surface that is usually smoothly contoured but can, if desired, be provided with longitudinally extending depressed or projecting surface decoration. In the exposed surface are one or more longitudinally extending grooves. Into each groove is inserted a flexible decorative cord, preferably of a color selected to provide an appealing visual effect, usually a color which contrasts with the color of the base strip itself. The decorative cord can be easily inserted into the groove by pressing it into place either at the factory or at the job site, to harmonize with the decor. The cord can be removed and replaced at any time desired, yet will be held securely in the groove by its contact with the walls of the groove during normal use.

Pallas et al., U.S. Pat. No. 6,604,331 describes an area between a wall and a floor of a building that can be covered by a baseboard-molding unit. The baseboard molding unit includes a wall-mounted track section that can be fixed to a wall by fasteners and which includes a dovetail joint element and a baseboard element that has a dovetail groove defined therein that is slidably, yet securely held on the dovetail joint element. Corner pieces are used for inside and for outside corners.

Our prior art search with abstracts described above teaches: an extrusion method and apparatus for producing a molding strip, an extruded elastomeric baseboard molding strip, a molding strip, particularly for vehicles, an indention-recoverable molding strip, several decorative molding strips, a flexible molding strip having inserted decorative cord and furniture provided with such strips, and a baseboard molding strip unit. The prior art teaches that molding strips may have plural horizontal recesses in a rear surface for improved adhesive flow and removal, and that such strips may have curved decorative front surfaces, and that such strips may have an integrated stiffener strip, and that the rear surface may be formed to accommodate a mounting strip, and that such strips may be made of thin material with plural separate parts cooperating especially where an inner portion supports and provides rigidity to an outer portion covering the inner portion, and that such strips may have front surface grooves for mounting decorative strips, and that a baseboard molding may have a dovetail slot on a rear surface for intimate engagement with a dovetail supporting and mounting strip engaged with a wall surface. The present invention, in contrast provides fulfills these needs and provides further related advantages as described in the following summary.

### SUMMARY OF THE INVENTION

The present invention teaches certain benefits in construction and use which give rise to the objectives described below.

In a best mode preferred embodiment of the present invention, a molding strip having a front face and a spaced apart rear face, the front and rear faces extend between parallel top and bottom edges. The front face is formed into a decorative curvature with a frontal groove running horizontally. An insert filler is adapted for press-fitting into the frontal groove. The bottom edge is indented from the front face such that with the body oriented uprightly, and in contact with a floor surface, a frontal space is formed between the floor surface and the front face. The rear surface comprises a plurality of parallel grooves separated by at least two parallel contact edges. A cutaway surface extends from the bottom surface to a medial position on the rear face, the cutaway surface sized for receiving a smaller, prior mounted, molding strip. The molding strip is thus able to cover an existing molding strip to provide improvement to an existing construction without stripping existing moldings.

A primary objective of one embodiment of the present invention is to provide an apparatus and method of use of such apparatus that yields advantages not taught by the prior art.

Another objective is to assure that an embodiment of the invention is capable of covering a prior mounted molding.

A further objective is to assure that an embodiment of the invention is capable of being painted without masking a floor surface and without getting paint on the floor surface.

A still further objective is to assure that an embodiment of the invention is capable of receiving a decorative filler strip without the need to bond or fasten the strip while still achieving a secure mounting.

A still further objective is to assure that an embodiment of the invention is capable of being mounted to a wall surface with protruding imperfections without difficulty and yet capable too of being supported by a generous amount of adhesive bonding material.

Other features and advantages of the embodiments of the present invention will become apparent from the following more detailed description, taken in conjunction with the accompanying drawings, which illustrate, by way of example, the principles of at least one of the possible embodiments of the invention.

### BRIEF DESCRIPTION OF THE DRAWINGS

The accompanying drawings illustrate at least one of the best mode embodiments of the present invention. In such drawings:

FIGS. 1-4 are perspective views of embodiments of the invention an elongate baseboard molding strip, wherein in each view only a short portion of such a strip is depicted and particularly showing a cross section in each view; and

FIG. 5 is an exploded perspective view of the embodiment of FIG. 2.

### DETAILED DESCRIPTION OF THE INVENTION

The above described drawing figures illustrate the present invention in at least one of its preferred, best mode embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

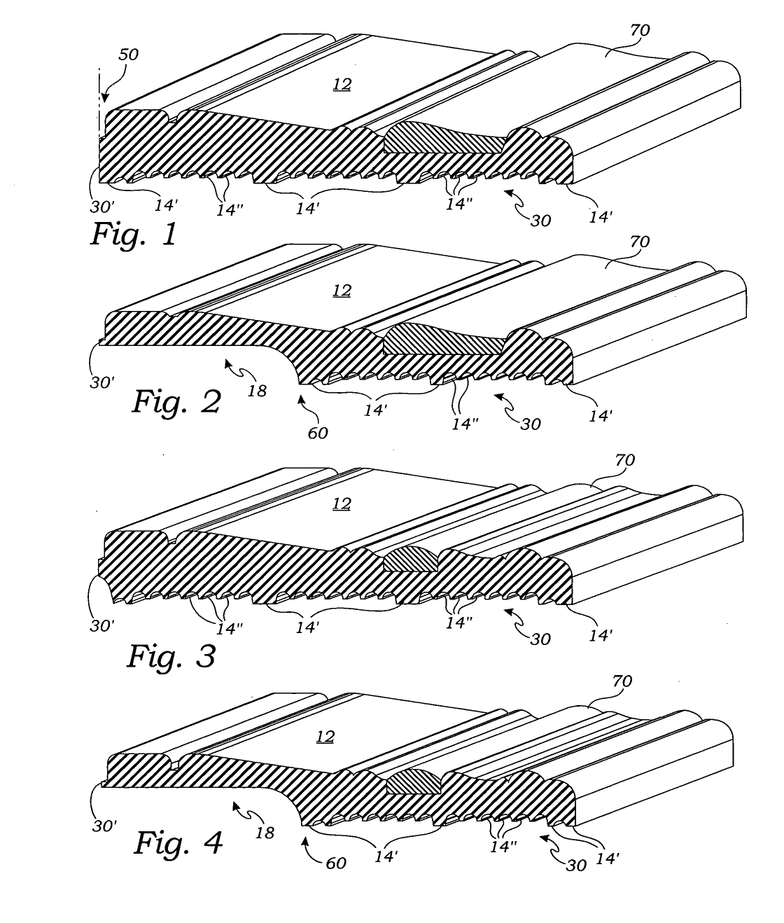

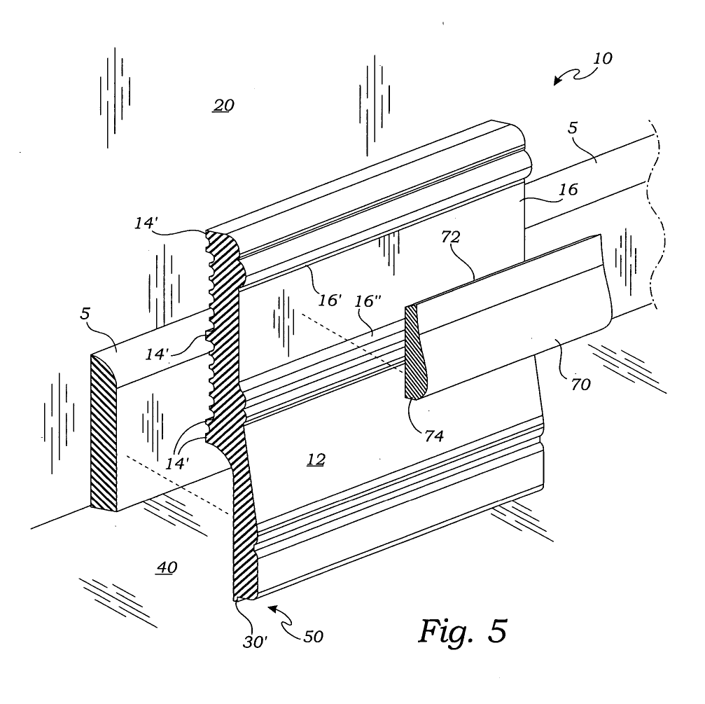

In one aspect of a best mode embodiment of the present invention, a baseboard molding strip apparatus 10 (“strip”) distinguishes over the prior art in several ways. Such a strip 10 is normally made of wood or of extruded plastic, but may also be made of other common and inexpensive materials by milling, molding and other well known processes. The molding strip 10 is mounted to a building vertical wall surface 20, with a bottom edge 30′ of the strip 10 in contact with a building horizontal floor surface 40. Such moldings are very common and are used to provide a finished look to a building interior. The strip 10 has a front decorative surface 12 and an opposite rear, wall contacting surface 30 as is well known. Such strips 10 are mounted to walls by nailing or gluing or both. In improving over the prior art, the bottom edge 30′ of the present inventive strip 10 is indented to form a horizontal frontal space 50 between the strip 10 and the floor surface 40 as shown in FIGS. 1 and 5. The advantage and reason for this indentation will be explained in due course.

A frontal horizontal slot 16 in the front decorative surface 12 has top 16′ and bottom 16″ slot edges. These edges 16′, 16″ diverge inwardly to better engaged a decorative insert filler strip 70 that may be used to provide a customized appearance to the strip 10. The rear, wall contacting surface 30 comprises a plurality of horizontal, vertically spaced contact edges 14′ all of which align along a plane so as to commonly contact the wall surface 20. These edges 14′ are interspersed by a plurality of horizontal, vertically spaced concave grooves 14″ for retaining an adhesive (not shown) used for mounting the strip 10. Such grooves 14″ enable the surface 30 to avoid difficulties with minor wall protrusions such as pimples and also to hold a greater amount of adhesive for an improved engagement with the wall to which it is attached.

Preferably, the strip 10 has a cutaway surface 18 extending from the bottom edge 30′, upwardly to a medial position 60 on the rear surface 30, such that with the rear, wall contacting edges 14′ abutting the building vertical wall surface 20, and with the bottom edge 30′ abutting the building horizontal floor surface 40, a lesser sized, existing molding strip 5 mounted to the building vertical wall surface 20, is concealed within the cutaway surface 18. This provides the great advantage of being able to install the strip 10 without removing prior mounted molding of a smaller size.

Preferably, the present invention further comprises the insert filler 70 which is adapted with divergent filler side edges 72 and 74 for positive engagement within the frontal horizontal slot 16. This is accomplished by tapering the filler side edges 72 and 74 to correspond with edges 16′ and 16″. Such diverging edges are preferably at an angle of between 1 and 3 degrees so as to assure a positive lock of the filler 70 within the slot 16 while still enabling engagement by simply pushing the filler 70 into the slot 16 where it snaps into place and is held without adhesive or nails, etc.

The indented bottom edge 30′ of the strip 10 provides the advantage, when installing the strip 10, of providing a solid footing to the strip 10, while enabling the strip 10 to be finished by staining, painting, or other surface finishing, without such finishing material inadvertently coming into contact with the building horizontal floor surface 40. Thus, a painter's barrier (not shown) such as a piece of cardboard or similar flat and stiff sheet stock material, may be held under the strip 10 during painting, etc. to assure that the floor surface 40 is not contacted. Such a barrier is moved along the strip 10 as finishing proceeds. This avoids the time and expense of using masking tape, which, of course, must be carefully placed and thereafter removed.

FIG. 1 shows an embodiment of the invention with filler 70, with indent space 50 and with parallel grooves 14″. FIG. 2 shows a similar strip 10 having also cutout 18. FIG. 3 shows a similar strip 10 with an alternate filler 70 showing that such a filler 70 may be made in various sizes and with varying decorative features. FIG. 4 shows the strip 10 of FIG. 3 with the cutout 18 showing that the cutout 18 may be included or not.

The enablements described in detail above are considered novel over the prior art of record and are considered critical to the operation of at least one aspect of one best mode embodiment of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of the embodiments of the herein described invention and its related embodiments not described are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

1. In a baseboard molding strip apparatus for adhesive mounting to a building vertical wall surface, with a bottom edge of the strip in contact with a building horizontal floor surface, the strip having a front decorative surface and an opposite rear, wall contacting surface, the improvement comprising: the bottom edge of the strip indented to form a horizontal frontal space between the strip and the floor surface; a frontal horizontal slot with top and bottom slot edges, said edges diverging inwardly; the rear, wall contacting surface comprising a plurality of horizontal, vertically spaced contact edges, the contact edges interspersed by a plurality of horizontal, vertically spaced grooves for retaining an adhesive.

2. The apparatus of claim 1 further comprising a cutaway surface extending from the bottom edge to a medial position on the rear surface, such that with the contact edges abutting the building vertical wall, and with the bottom edge abutting the building horizontal floor, a lesser sized molding strip mounted to the building vertical wall is concealed within the cutaway surface.

3. A molding strip apparatus comprising: a front decorative surface and a spaced apart rear, wall contacting surface, the wall contacting surface comprising a plurality of horizontal, vertically spaced apart contact edges interspersed by a plurality of horizontal, vertically spaced concave grooves.

4. The apparatus of claim 3 further comprising a frontal horizontal slot with top and bottom slot edges, said slot edges diverging inwardly for receiving an insert filler adapted for press-fitting into the frontal horizontal slot.

5. The apparatus of claim 4 further comprising the insert filler, adapted with divergent filler side edges for positive engagement within the frontal horizontal slot of the apparatus.

6. The apparatus of claim 3 further comprising an indented bottom edge of the strip forming a horizontal frontal space between the strip and a floor surface below the appartus.

7. In a baseboard molding strip apparatus for adhesive mounting to a building vertical wall surface having an existing lesser sized molding strip attached thereto, and wherein the baseboard molding strip provides a bottom edge of the strip in contact with a building horizontal floor surface, the baseboard molding strip having a front decorative surface and an opposite rear, wall contacting surface, the improvement comprising: the bottom edge of the strip indented to form a horizontal frontal space between the strip and the floor surface; a frontal horizontal slot with top and bottom slot edges, said edges diverging inwardly; the rear, wall contacting surface comprising a plurality of horizontal, vertically spaced contact edges, the contact edges interspersed by a plurality of horizontal, vertically spaced grooves for retaining an adhesive; and a cutaway rear surface extending from the bottom edge to a medial position on the rear surface, such that with the rear, wall contacting edges abutting the building vertical wall, and with the bottom edge abutting the building horizontal floor, the lesser sized molding strip is concealed within the cutaway surface.
